(19) United States
(12) Patent Application Publication
(10) Pub. No.: US 2010/0001544 A1
(43) Pub. Date: Jan. 7, 2010

(54) Tailgate Storage

(76) Inventor: Richard John Paley, Corvallis, OR (US)

Correspondence Address: Richard Paley, 1320 NW Spring St, Corvallis, OR, 97330, US

(21) Appl. No.: 12/168,143

(22) Filed: Jul. 6, 2008

(51) Int. Cl. B62D 33/03

(52) U.S. Cl. 296/57.1; 296/51

(57) ABSTRACT

A tailgate constructed such that it can be lowered from the vertical to a position inside the cargo box of the pickup truck. The tailgate, when stowed, will lie horizontally, flush with the bed of the cargo box. The tailgate is thus no longer acting as an air dam but is easily accessible when needed.

### FIELD OF INVENTION

This invention is for a method of storing a tailgate for truck boxes or trailers to minimize wind resistance. At the same time, the tailgate is still in position at the end of the cargo box and ready for use.

### BACKGROUND OF INVENTION

The tailgates for truck boxes or trailers are normally stored in their vertical position at the rear of the truck box or trailer. This can cause appreciable wind resistance.

It is more fuel-efficient to run the truck with the tailgate out of the wind stream. This has traditionally meant either removing the tailgate entirely or lowering it outward to its load/unload position.

If the tailgate is removed entirely, it must be stored someplace other than at the rear of the truck or trailer bed and then replaced for use. If the tailgate is lowered outward, it is subject to damage and could obscure the license plate.

Lowering the tailgate into the box for storage allows it to be available for immediate use and keeps it safe from damage.

### DESCRIPTION OF INVENTION

The present invention provides a tailgate that can be dropped down for loading and closed for hauling in a conventional manner. However, the tailgate has a third position available-closed into the cargo box and lying on the bed of the box. This allows the tailgate to be stowed with no special equipment and with a minimum of effort. The tailgate must fulfill these conditions:
1) It will meet no obstructions when it is lowered into the cargo bed. The outer face of the tailgate cannot extend past the opening that the tailgate covers, that is, it cannot be wider than the opening.
2) It will lie flat on the cargo bed and be clamped in place. The tailgate will hinge forward, into the cargo box, until it is parallel to the bed of the box, and the inner face of the tailgate is flush with the bed of the box.
3) It will be clamped in a vertical position, as is normal to contain cargo. This will be the same clamping system that will hold the tailgate firmly in its stowed position.
4) It will lie parallel to and flush with the floor of the cargo bed when it has been opened outward, as is normal for loading and unloading the cargo.

While one method of achieving the desired stowage has been given, it is recognized that there can be many variations. For example, the clamping system could consist of bars that extend into the sidewalls of the cargo bed at the vertical and stowed positions. Thus it is to be understood that it is the concept is defined in the claims.

### BRIEF DESCRIPTION OF THE DRAWINGS

FIG. 1 shows the tailgate in its normal, upright position. The shaded section is the tailgate, the unshaded is the bed of the pickup truck. The inner face of the tailgate is centered on its hinge.

FIG. 2 shows the tailgate (shaded) in its stowed position, lying on the bed of the pickup truck. The fact that the inner face of the tailgate is centered on its hinge allows the tailgate to lie flush on the bed of the pickup truck.

FIG. 3 shows the tailgate (shaded) open for loading or unloading. The fact that the inner face of the tailgate is centered on its hinge means the tailgate and bed of the pickup will be at the same level.

FIG. 4 depicts a pickup truck with its tailgate stowed in the new position.

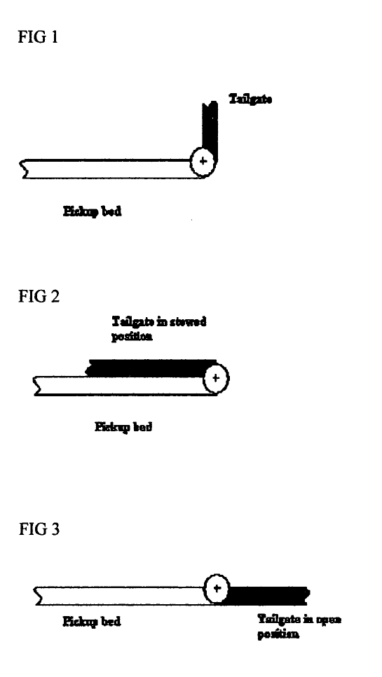

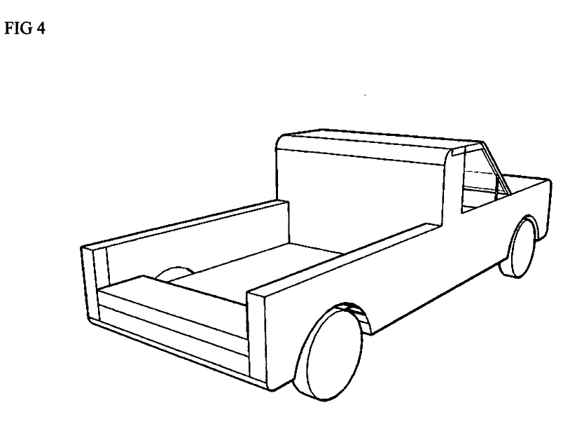

I claim:

1. A pickup truck comprising a truck bed behind the cab. The bed has side walls and a tailgate.

2. The tailgate of claim 1 is constructed so:
it can be lowered into the bed of the pickup truck without obstruction;
it can lie flat on the bed of the pickup truck without interference from the wheel wells;
it can be dropped outward to lie horizontally, parallel to and flush with the bed of the pickup truck;
when it is dropped into the cargo bed, it will be clamped in place using the same clamping system that holds it in the vertical position.

3. The tailgate of claim 1 can be constructed so its inner face is centered over its hinges. This will allow the tailgate to lie flat on the bed of the pickup when lowered into the bed, and to lie flush with the bed when the tailgate is lowered outward, which is the normal load/unload position for a pickup truck tailgate.
